(19) United States
(12) Patent Application Publication
(10) Pub. No.: US 2024/0217993 A1
(43) Pub. Date: Jul. 4, 2024

(54) METAL-CONTAINING SILYLOXY COMPOUND, METAL-CONTAINING SILYLOXY GROUP-COATED PARTICLES, METHOD FOR PRODUCING SAME, AND DISPERSION COMPOSITION

(71) Applicant: TOKYO OHKA KOGYO CO., LTD., Kanagawa (JP)

(72) Inventors: YuehChun LIAO, Kanagawa (JP); Michihito TAKAHASHI, Kanagawa (JP)

(21) Appl. No.: 18/555,306

(22) PCT Filed: Mar. 22, 2022
(86) PCT No.: PCT/JP2022/013105

§ 371 Date: Oct. 13, 2023

(30) Foreign Application Priority Data
Apr. 16, 2021 (JP) 2021-069877

(51) Int. Cl. C07F 7/18; C01G 23/053

(52) U.S. Cl. CPC C07F 7/188; C01G 23/053

(57) ABSTRACT

Provided are: a compound used as a capping agent which imparts particles having excellent dispersibility and refractive index; particles coated with the compound; a method for producing the same; and a dispersion composition containing said particles. A compound according to the present invention has a structure represented by formula (1). In the formula, R¹ represents an organic group having 1-30 carbon atoms, R² represents a group represented by OR³ or a group represented by formula (2), R³ represents an organic group having 1-30 carbon atoms, n1 and n2 each represent an integer of at least 0, n1+2×n2 represents a valence determined by the type of L, L represents aluminum, gallium, yttrium, titanium, zirconium, hafnium, bismuth, tin, vanadium, or tantalum, * represents a bond, R⁴ and R⁵ each represent an organic group having 1-30 carbon atoms which may have an oxygen atom. Particles according to the present invention have a structure represented by formula (1) on a surface thereof.

### TECHNICAL FIELD

The present invention relates to a metal-containing silyloxy compound, metal-containing silyloxy group-coated particles, a production method thereof, and a dispersion composition.

### BACKGROUND ART

High refractive index materials are used in the formation of optical components. As a high refractive index material, for example, compositions obtained by dispersing metal oxide particles such as zirconium oxide in an organic component are used. As a method for improving dispersibility of metal oxide particles, a method of capping the surface of metal oxide particles with a capping agent is known. As the capping agent, for example, organosilane such as n-propyltrimethoxysilane or the like is known (see Patent Document 1).

### CITATION LIST

### Patent Document

Patent Document 1: Japanese Patent No. 6698591

### DISCLOSURE OF THE INVENTION

### Problems to be Solved by the Invention

In recent years, as the optical components are required to have more improved performance, the high refractive index materials are also required to have higher refractive indices.

The present invention has been made in consideration of the conventional circumstances as above, and it is an object of the present invention to provide a compound that is used as a capping agent for giving particles excellent in dispersibility and refractive index, particles coated with the compound on the surface, a method for producing the same, and a dispersion composition containing the particles.

### Means for Solving the Problems

The present inventors have intensively studied to solve the above problems. As a result, the inventors have found that the above-mentioned problems can be solved by a predetermined metal-containing silyloxy compound, and completed the present invention. Specifically, the present invention provides the following.

A first aspect of the present invention relates to a compound having a structure represented by the following formula (1):

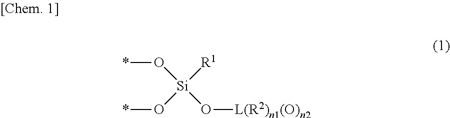

wherein
R¹ represents an organic group having 1 to 30 carbon atoms;
R² represents a group represented by OR³ or a group represented by the following formula (2);
R³ represents an organic group having 1 to 30 carbon atoms, and n1 and n2 each independently represent an integer of 0 or more, provided that n1+2×n2 is a valence determined by the type of L, and
L represents aluminum, gallium, yttrium, titanium, zirconium, hafnium, bismuth, tin, vanadium, or tantalum, and
represents a bond;

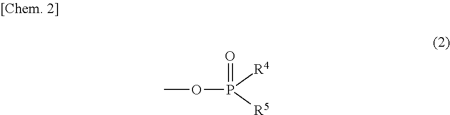

wherein R⁴ and R⁵ each represent an organic group having 1 to 30 carbon atoms which may have an oxygen atom.

A second aspect of the present invention relates to a particle having a structure represented by the formula (1) on the surface.

A third aspect of the present invention relates to a dispersion composition including the particles.

A fourth aspect of the present invention relates to a method for producing particles having a structure represented by the formula (1) on the surface,
the producing method including:
a particle coating step of reacting particles having a hydroxyl group on the surface with a compound represented by the following formula (30) to obtain particles having a structure represented by the formula (1) on the surface,
or
the producing method including:
a first reaction step of reacting particles having a hydroxyl group on the surface with a compound represented by the following formula (4) to obtain particles having a structure represented by the following formula (5) on the surface; and
a second reaction step of reacting the particles obtained in the first reaction step with a compound represented by the following formula (6) to obtain particles having a structure represented by the formula (1) on the surface,

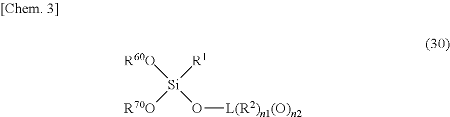

wherein R¹, R², n1, n2, and L are as defined above, and R⁶⁰ and R⁷⁰ each represent an organic group having 1 to 30 carbon atoms,

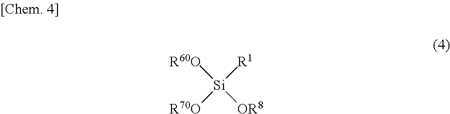

wherein R¹, R⁶⁰, and R⁷⁰ are as defined above, and R⁸ represents an organic group having 1 to 30 carbon atoms,

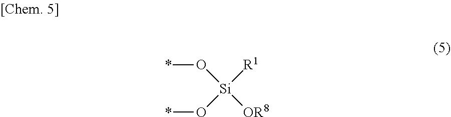

wherein R¹ and R⁸ are as defined above,

R⁹O-L(R²)ₙ₁(O)ₙ₂ (6)
wherein R², n1, n2, and L are as defined above, and R⁹ represents an organic group having 1 to 30 carbon atoms.

### Effects of the Invention

According to the present invention, it is possible to provide a compound that can be used as the capping agent for producing particles excellent in dispersibility and refractive index, particles coated with the compound on the surface, a method for producing the same, and a dispersion composition containing the particles.

### PREFERRED MODE FOR CARRYING OUT THE INVENTION

### <Compound Having Structure Represented by Formula (1)>

The compound according to the present invention has a structure represented by the formula (1). The compound can be used as the capping agent which provides particles excellent in dispersibility and refractive index.

In the formula (1), the organic group having 1 to 30 carbon atoms and represented by R¹ is not particularly limited, and examples thereof include an alkyl group having 1 to 30 carbon atoms, a cycloalkyl group having 3 to 30 carbon atoms, an alkenyl group having 2 to 30 carbon atoms, an aryl group having 6 to 30 carbon atoms, and an alkoxyalkyl group having 2 to 30 carbon atoms. Among them, an alkyl group having 1 to 30 carbon atoms or an alkoxyalkyl group having 2 to 30 carbon atoms is preferable from the viewpoint of dispersibility of the particles obtained.

The alkyl group having 1 to 30 carbon atoms and represented by R¹ is not particularly limited, and examples thereof include a methyl group, an ethyl group, a propyl group, an isopropyl group, a butyl group, a tert-butyl group, a n-pentyl group, an isopentyl group, a sec-pentyl group, a tert-pentyl group, a n-hexyl group, an isohexyl group, a sec-hexyl group, a tert-hexyl group, a n-heptyl group, a n-octyl group, a n-decyl group, a n-dodecyl group, a n-octadecyl group, and a n-icosyl group. From the viewpoints of easiness of synthesis of the compound and dispersibility of the particles obtained, an alkyl group having 6 to 24 carbon atoms is preferable, and an alkyl group having 8 to 20 carbon atoms is more preferable.

The cycloalkyl group having 3 to 30 carbon atoms and represented by R¹ is not particularly limited, and examples thereof include a cyclopropyl group, a cyclobutyl group, a cyclopentyl group, a cyclohexyl group, a cycloheptyl group, a cyclooctyl group, a cyclodecyl group, a cyclododecyl group, a cyclooctadecyl group, and a cycloicosyl group. From the viewpoints of easiness of synthesis of the compound, dispersibility of the particles obtained, and the like, cycloalkyl group having 6 to 24 carbon atoms is preferable, and a cycloalkyl group having 8 to 20 carbon atoms is more preferable.

The alkenyl group having from 2 to 30 carbon atoms and represented by R¹ is not particularly limited, and examples thereof include a vinyl group and an allyl group. From the viewpoints of easiness of synthesis of the compound, dispersibility of the particles obtained, and the like, an alkenyl group having from 6 to 24 carbon atoms is preferable, and an alkenyl group having from 8 to 20 carbon atoms is more preferable.

The aryl group having 6 to 30 carbon atoms and represented by R¹ is not particularly limited, and examples thereof include a phenyl group and a naphthyl group. From the viewpoints of easiness of synthesis of the compound, dispersibility of the particles obtained, and the like, an aryl group having 8 to 24 carbon atoms is preferable, and an aryl group having 10 to 20 carbon atoms is more preferable.

The alkoxyalkyl group having 2 to 30 carbon atoms and represented by R¹ is not particularly limited, and examples thereof include a methoxymethyl group, a methoxyethyl group, an ethoxymethyl group and an ethoxyethyl group. From the viewpoints of easiness of synthesis of the compound, dispersibility of the particles obtained, and the like, an alkoxyalkyl group having 6 to 24 carbon atoms is preferable, and an alkoxyalkyl group having 8 to 20 carbon atoms is more preferable.

In the formula (1), when n1 represents an integer of 2 or more, plural R² may be the same as or different from each other.

In the formula (1), R² is represented, for example, by OR³, and examples of R³ include an alkyl group having 1 to 30 carbon atoms, a cycloalkyl group having 3 to 30 carbon atoms, an alkenyl group having 2 to 30 carbon atoms, an aryl group having 6 to 30 carbon atoms, or an alkoxyalkyl group having 2 to 30 carbon atoms, as well as an alkylacetoacetate group having 5 to 30 carbon atoms, a 2,4-pentanedionato group (i.e. acetylacetonato group), or a 2,2,6,6-tetramethyl-3,5-heptanedionato group.

Examples of the alkyl acetoacetate group having 5 to 30 carbon atoms and represented by R² include, but are not limited to, a methylacetoacetate group and an ethylacetoacetate group. From the viewpoints of easiness of synthesis, stability, and the like, an ethylacetoacetate group is preferable.

R² is preferably a group represented by the formula (2) from the viewpoints of dispersibility or the like of the particles obtained.

In the formula (1), L is preferably yttrium, titanium, zirconium, or hafnium, and more preferably titanium or zirconium, from the viewpoint of the refractive index or the like of the particles obtained.

In the formula (2), the organic group having 1 to 30 carbon atoms and represented by R⁴ or R⁵ is not particularly limited, and examples thereof include an alkyl group having 1 to 30 carbon atoms, a cycloalkyl group having 3 to 30 carbon atoms, an alkenyl group having 2 to 30 carbon atoms, an aryl group having 6 to 30 carbon atoms, and an alkoxyalkyl group having 2 to 30 carbon atoms, and an alkyl group having 1 to 30 carbon atoms or an alkoxyalkyl group having 2 to 30 carbon atoms is preferable from the viewpoint of dispersibility or the like of the particles obtained. When R⁴ or R⁵ has an oxygen atom, the oxygen atom is preferably directly bonded to P in P(═O) in the formula (2), that is, the organic group having 1 to 30 carbon atoms is preferably bonded to P via the oxygen atom, and the organic group is preferably an alkyl group having 1 to 30 carbon atoms or an alkoxyalkyl group having 2 to 30 carbon atoms. In the formula (2), both R⁴ and R⁵ may have an oxygen atom directly bonded to P in P(═O), or only one of R⁴ and R⁵ may have the oxygen atom.

The alkyl group having 1 to 30 carbon atoms and represented by R⁴ or R⁵ is not particularly limited, and examples thereof include groups specifically exemplified for R¹. From the viewpoints of easiness of synthesis of the compound and dispersibility of the particles obtained, an alkyl group having 4 to 18 carbon atoms is preferable, and an alkyl group having 6 to 12 carbon atoms is more preferable.

The cycloalkyl group having 3 to 30 carbon atoms and represented by R⁴ or R⁵ is not particularly limited, and includes, for example, groups specifically exemplified for R¹. From the viewpoints of easiness of synthesis of the compound and dispersibility of the particles obtained, a cycloalkyl group having 4 to 18 carbon atoms is preferable, and a cycloalkyl group having 6 to 12 carbon atoms is more preferable.

The alkenyl group having 2 to 30 carbon atoms and represented by R⁴ or R⁵ is not particularly limited, and includes, for example, groups specifically exemplified for R¹. From the viewpoints of easiness of synthesis of the compound, dispersibility of the particles obtained, and the like, an alkenyl group having 4 to 18 carbon atoms is preferable, and an alkenyl group having 6 to 12 carbon atoms is more preferable.

The aryl group having 6 to 30 carbon atoms and represented by R⁴ or R⁵ is not particularly limited, and examples thereof include groups specifically exemplified for R¹. From the viewpoints of easiness of synthesis of the compound, dispersibility of the particles obtained, an aryl group having 6 to 18 carbon atoms is preferable, and an aryl group having 6 to 12 carbon atoms is more preferable.

The alkoxyalkyl group having 2 to 30 carbon atoms and represented by R⁴ or R⁵ is not particularly limited, and examples thereof include groups specifically exemplified for R¹. From the viewpoints of easiness of synthesis of the compound, dispersibility of the particles obtained, and the like, an alkoxyalkyl group having 4 to 18 carbon atoms is preferable, and an alkoxyalkyl group having 6 to 12 carbon atoms is more preferable.

The compound having the structure represented by the formula (1) is preferably represented by the formula (3), more preferably represented by the formula (30) from the viewpoints of easiness of synthesis, reactivity as a capping agent, and the like.

In the formula (3), the organic group having 1 to 30 carbon atoms and represented by R⁶ or R⁷ is not particularly limited, and examples thereof include an alkyl group having 1 to 30 carbon atoms, a cycloalkyl group having 3 to 30 carbon atoms, an alkenyl group having 2 to 30 carbon atoms, an aryl group having 6 to 30 carbon atoms, and an alkoxyalkyl group having 2 to 30 carbon atoms, and include groups specifically exemplified for each R¹. Among them, an alkyl group having 1 to 30 carbon atoms is preferable.

The alkyl group having 1 to 30 carbon atoms and represented by R⁶ or R⁷ is not particularly limited, and includes, for example, groups specifically exemplified for R¹. From the viewpoints of reactivity as a capping agent and the like, an alkyl group having 1 to 6 carbon atoms, such as a methyl group, an ethyl group, a propyl group, an isopropyl group, a butyl group, a tert-butyl group, a n-pentyl group, an isopentyl group, a sec-pentyl group, a tert-pentyl group, a n-hexyl group, an isohexyl group, a sec-hexyl group, or a tert-hexyl group, is preferable.

In the formula (30), the organic group having 1 to 30 carbon atoms and represented by R⁶⁰ or R⁷⁰ is the same as explained for the organic group having 1 to 30 carbon atoms and represented by R⁶ or R⁷ in the formula (3).

Examples of the compound represented by the formula (3) include the following compounds.

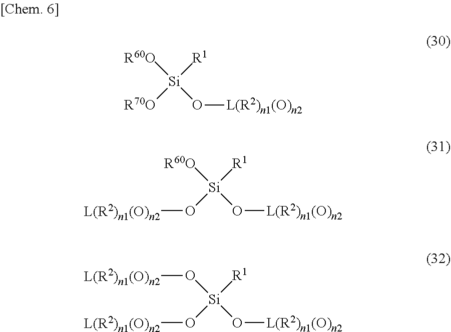

wherein R¹, R², n1, n2, L, R⁶⁰, and R⁷⁰ are as defined above.

Specific examples of the compound having the structure represented by the formula (1) are as follows, but the present invention is not limited thereto.

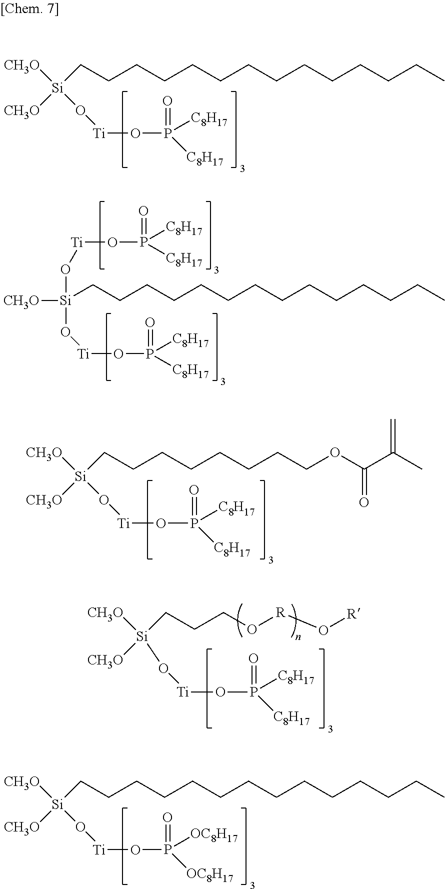

wherein R represents an alkylene group having 1 to 3 carbon atoms, R′ represents an alkyl group having 1 to 3 carbon atoms, and n represents a number of 0 or more, for example, a number of 0 or more and 10 or less, preferably a number of 0 of more and 5 or less.

The compound having the structure represented by the formula (1) can be produced using any organic synthesis reaction, for example, according to Scheme 1 below.

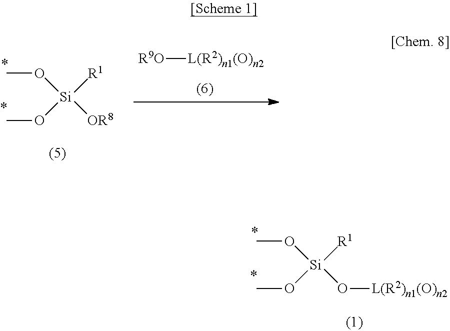

wherein R¹, R², n1, n2, L, R⁸, R⁹, and * are as defined above.

In Scheme 1, the compound having a structure represented by the formula (1) is obtained by hydrolyzing and condensing a compound having a structure represented by the formula (5) and a compound represented by the formula (6) in the absence or presence of a catalyst in water or a mixed solvent (referring to a mixture of water and an organic solvent, hereinafter the same applies).

The catalyst may be an acid catalyst or an alkali catalyst. Examples of the acid catalyst include inorganic acids, aliphatic sulfonic acids, aromatic sulfonic acids, aliphatic carboxylic acids and aromatic carboxylic acid. Specific examples include hydrofluoric acid, hydrochloric acid, hydrobromic acid, sulfuric acid, nitric acid, perchloric acid, phosphoric acid, methanesulfonic acid, benzenesulfonic acid, toluenesulfonic acid, formic acid, acetic acid, propionic acid, oxalic acid, malonic acid, maleic acid, fumaric acid, and benzoic acid. Examples of the alkali catalyst include: methylamine, ethylamine, propylamine, butylamine, ethylenediamine, hexamethylenediamine, dimethylamine, diethylamine, ethylmethylamine, trimethylamine, triethylamine, tripropylamine, tributylamine, cyclohexylamine, dicyclohexylamine, monoethanolamine, diethanolamine, dimethyl monoethanolamine, monomethyldiethanolamine, triethanolamine, diazabicyclooctane, diazabicyclononene, diazabicycloundecene, hexamethylene tetramine, aniline, N,N-dimethylaniline, pyridine, N,N-dimethylethanolamine, N,N-diethylethanolamine, N-(β-aminoethyl)ethanolamine, N-methylethanolamine, N-methyldiethanolamine, N-ethylethanolamine, N-n-butylethanolamine, N-n-butyldiethanolamine, N-tert-butylethanolamine, N-tert-butyldiethanolamine, N,N-dimethylaminopyridine, pyrrole, piperazine, pyrrolidine, piperidine, picoline, tetramethylammonium hydroxide, choline hydroxide, tetrapropylammonium hydroxide, tetrabutylammonium hydroxide, ammonia, lithium hydroxide, sodium hydroxide, potassium hydroxide, barium hydroxide, and calcium hydroxide.

The used amount of the catalyst is preferably 10⁻⁶ mol to 10 mol, more preferably 10⁻⁵ mol to 5 mol, and most preferably 10⁻⁴ mol to 1 mol, with respect to 1 mol of the compound represented by the formula (6).

The used amount of water is preferably 0.01 to 100 mol, more preferably 0.05 to 50 mol, more preferably 0.1 to 30 mol, and most preferably 0.5 to 5 mol, with respect to 1 mol of the group represented by OR⁹ in the compound represented by formula (6).

Examples of the organic solvent include: methanol, ethanol, 1-propanol, 2-propanol, 1-butanol, 2-butanol, 2-methyl-1-propanol, acetone, acetonitrile, tetrahydrofuran, toluene, hexane, ethyl acetate, cyclohexanone, methyl amyl ketone, butanediol monomethyl ether, propylene glycol monomethyl ether, ethylene glycol monomethyl ether, butanediol monoethyl ether, propylene glycol monoethyl ether, ethylene glycol monoethyl ether, propylene glycol dimethyl ether, diethylene glycol dimethyl ether, propylene glycol monomethyl ether acetate (PGMEA), propylene glycol monoethyl ether acetate, ethyl pyruvate, butyl acetate, methyl 3-methoxypropionate, ethyl 3-ethoxypropionate, ethyl 3-ethoxypropionate, tert-butyl acetate, t-butyl propionate; propylene glycol mono-t-butyl ether acetate, γ-butyrolactone, acetylacetone, methyl acetoacetate, ethyl acetoacetate, propyl acetoacetate, butyl acetoacetate, methyl pivaloyl acetate, methyl isobutyroyl acetate, methyl caproylacetate, methyl lauroylacetate, 1,2-ethanediol, 1,2-propanediol, 1,2-butanediol, 1,2-pentanediol, 2,3-butanediol, 2,3-pentanediol, glycerin, diethylene glycol, and hexylene glycol. Mixtures of two or more thereof are preferred.

The used amount of the organic solvent is preferably 0 ml or more and 1,000 ml or less, and more preferably 0 ml or more and 500 ml or less, with regard to 1 mol of the compound represented by the formula (6).

The reaction temperature is preferably 0° C. or higher and 100° C. or lower, and more preferably 5° C. or higher and 80° C. or lower. The reaction time is preferably 10 minutes or more and 3 hours or less, and more preferably 20 minutes or more and 1 hour or less.

Among them, the compound represented by the formula (3) can be produced, for example, according to Scheme 2 below.

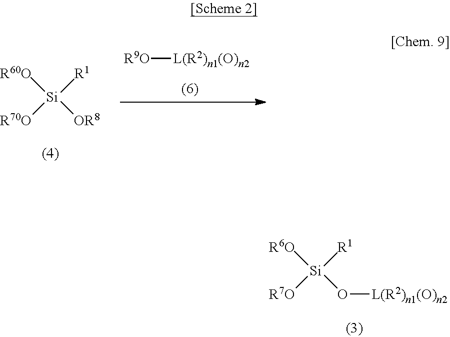

wherein R¹, R², n1, n2, L, R⁶, R⁷, R⁶⁰, R⁷⁰, R⁸, and R⁹ are as defined above.

In Scheme 2, the compound represented by the formula (3) is obtained by hydrolyzing and condensing the compound represented by the formula (4) and the compound represented by the formula (6) in the same manner as in Scheme 1.

The organic group having 1 to 30 carbon atoms and represented by R⁸ in the formula (5) is the same as explained for the organic group having 1 to 30 carbon atoms and represented by R⁶ or R⁷ in the formula (3).

In the formula (6), the organic group having 1 to 30 carbon atoms and represented by R⁹ is not particularly limited, and examples thereof include an alkyl group having 1 to 30 carbon atoms, a cycloalkyl group having 3 to 30 carbon atoms, an alkenyl group having 2 to 30 carbon atoms, an aryl group having 6 to 30 carbon atoms, and an alkoxyalkyl group having 2 to 30 carbon atoms, and include groups specifically exemplified for each R¹. Among them, an alkyl group having 1 to 30 carbon atoms is preferable.

The alkyl group having 1 to 30 carbon atoms and represented by R⁹ is not particularly limited, and examples thereof include groups specifically exemplified for R⁶ or R⁷. From the viewpoints of easiness of synthesis and reactivity with the group represented by OR⁸, a methyl group, an ethyl group, a propyl group, an isopropyl group, a butyl group, a tert-butyl group, a n-pentyl group, an isopentyl group, a sec-pentyl group, a tert-pentyl group, a n-hexyl group, an isohexyl group, a sec-hexyl group, and a tert-hexyl group. An alkyl group having 1 to 6 carbon atoms is preferable.

### <Particles Having Structure Represented by Formula (1) on Surface>

The particles according to the present invention have a structure represented by the formula (1). Since the particles are excellent in dispersibility and refractive index, they can be suitably used for high refractive index materials.

The particles having a structure represented by the formula (1) on the surface have, for example, a form in which the structure represented by the formula (1) is introduced into the surface of the particles having no structure represented by the formula (1) on the surface. The particles having no structure represented by the formula (1) on the surface are not particularly limited, and examples thereof include particles having a hydroxyl group on the surface. The particles having a hydroxy group on the surface thereof are not particularly limited, and metal oxide particles such as titanium oxide particles, zirconium oxide particles, and hafnium oxide particles; and other particles having a high refractive index, such as Si particles, can be exemplified.

The particle diameter of the particles according to the present invention is not particularly limited, and is preferably 1 to 20 nm, more preferably 2 to 15 nm, and most preferably 4 to 10 nm from the viewpoints of dispersibility and the like. In this specification, the particle size of particles refers to a particle size measured by observing particles with TEM.

In the case of measuring an average diameter of a dispersion composition containing the particles according to the present invention, the average diameter can be measured by a dynamic light scattering (DLS) apparatus such as Malvern Zetasizer Nano S, etc. For example, when the particles according to the present invention are dispersed in a dispersion medium such as PGMEA, etc. at a concentration of 5% by mass or less, monodispersibility is obtained, and the average diameter range is 20 nm or less.

The dispersion composition according to the present invention has, for example, a combination of the particles according to the present invention and a known organic solvent or a known liquid monomer, etc., and maintains dispersibility of the particles according to the present invention in the combination.

The structure represented by the formula (1) is bonded to a particle through at least one bond. The form of the bond between the structure represented by the formula (1) and the particle is not particularly limited, and examples thereof include the following forms (F1a) and (F1b). In the following form (F1a), the structure represented by the formula (1) is bonded to a particle via both bonds. On the other hand, in the following form (F1b), the structure represented by the formula (1) is bonded to a particle via one bond.

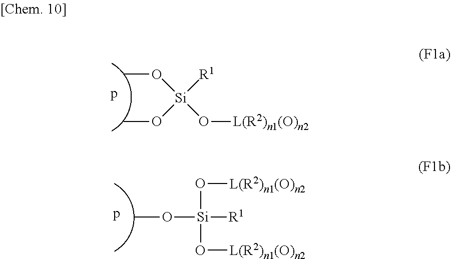

wherein R¹, R², n1, n2, and L are as defined above, and p represents a particle.

### [Method for Preparing Particles Having Structure Represented by Formula (1)]

The particles having the structure represented by the formula (1) on the surface can be produced, for example, as described above, by the producing method having a particle coating step (hereinafter, also referred to as “producing method 1”) or the producing method having a first reaction step and a second reaction step (hereinafter, also referred to as “producing method 2”).

The particle coating step, the first reaction step, and the second reaction step can be performed, for example, in the absence or presence of a catalyst, in water or a mixed solvent. Examples of the catalyst, examples of the organic solvent, the reaction temperature, and the reaction time are similar to those described in Scheme 1.

The producing method 1 can be performed, for example, according to Scheme 3 or 4 below.

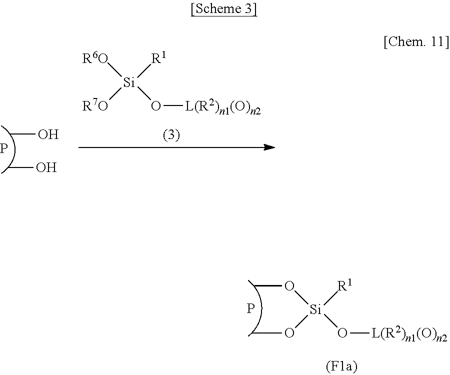

wherein R¹, R², n1, n2, L, R⁶, R⁷, and p are as defined above.

In Scheme 3, particles having a structure represented by the formula (1) on the surface as the form (F1a) are obtained by hydrolyzing and condensing particles having hydroxy groups on the surface and a compound represented by the formula (3) in water or a mixed solvent in the absence or presence of a catalyst. Examples of the catalyst, examples of the organic solvent, the reaction temperature, and the reaction time are the same as those described in Scheme 1.

The used amount of the catalyst is preferably 10⁻⁶ mol to 10 mol, more preferably 10⁻⁵ mol to 5 mol, and most preferably 10⁻⁴ mol to 1 mol, with respect to 1 mol of the compound represented by the formula (3).

The used amount of water is preferably 0.01 to 100 mol, more preferably 0.05 to 50 mol, more preferably 0.1 to 30 mol, and most preferably 1 to 5 mol with respect to 1 mol of the total of the group represented by OR⁶ and the group represented by OR⁷ in the compound represented by the formula (3).

The used amount of the organic solvent is preferably 0 to 1,000 ml, and more preferably 0 to 500 ml, with respect to 1 mol of the compound represented by the formula (3).

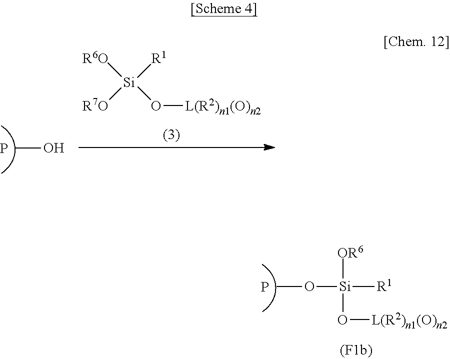

wherein R¹, R², n1, n2, L, R⁶, R⁷, and p are as defined above.

In Scheme 4, particles having a structure represented by the formula (1) as the form (F1b) are obtained by hydrolyzing and condensing particles having a hydroxy group and the compound represented by the formula (3) in the absence or presence of a catalyst in water or a mixed solvent. Examples of the catalyst, examples of the organic solvent, the reaction temperature, and the reaction time are similar to those described in Scheme 3.

In Scheme 4, R⁶ is preferably a group represented by L(R²)ₙ₁(O)ₙ₂.

The used amount of water is preferably 0.01 to 100 mol, more preferably 0.05 to 50 mol, and most preferably 0.1 to 30 mol, with respect to 1 mol of the group represented by OR⁷ in the compound represented by the formula (3).

The producing method 2 can be performed, for example, according to Scheme 5 below.

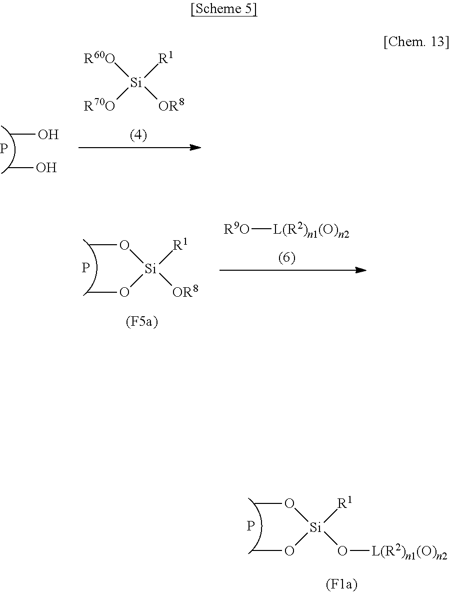

wherein R¹, R², n1, n2, L, R⁶⁰, R⁷⁰, R⁸, R⁹, and p are as defined above.

In Scheme 5, particles having a hydroxyl group on the surface and the compound represented by the formula (4) are hydrolyzed and condensed in water or a mixed solvent in the absence or presence of a catalyst to obtain particles having a structure represented by the formula (5) on the surface as the form (F5a) (first reaction step), and the particles obtained and the compound represented by the formula (6) are hydrolyzed and condensed in water or a mixed solvent in the absence or presence of a catalyst to obtain particles having the structure represented by the formula (1) as the form (F1a) on the surface (second reaction step). Examples of the catalyst and the organic solvent are the same as those described in Scheme 1.

The used amount of the catalyst is preferably 10⁻⁶ mol to 10 mol, more preferably 10⁻⁵ mol to 5 mol, and most preferably 10⁻⁴ mol to 1 mol with respect to 1 mol of the compound represented by the formula (4) in the case of the first reaction step or with respect to 1 mol of the compound represented by the formula (6) in the case of the second reaction step.

The used amount of water is preferably 0.01 to 100 mol, more preferably 0.05 to 50 mol, more preferably 0.1 to 30 mol, and most preferably 1 to 5 mol, with respect to 1 mol of the total of the group represented by OR⁶⁰ and the group represented by OR⁷⁰ in the compound represented by the formula (4) in the case of the first reaction step, or with respect to 1 mol of the group represented by OR⁹ in the compound represented by the formula (6) in the case of the second reaction step.

The used amount of the organic solvent is preferably 0 to 1,000 ml, and more preferably 0 to 500 ml with respect to 1 mol of the compound represented by the formula (4) in the first reaction step or with respect to 1 mol of the compound represented by the formula (6) in the second reaction step.

In each of the first reaction step and the second reaction step, the reaction temperature is preferably 0 to 100° C., and more preferably 5 to 80° C., and the reaction time is preferably 10 minutes to 3 hours, and more preferably 20 minutes to 1 hour.

### Examples

Hereinafter, the present invention will be described in more detail with reference to the Examples, but the present invention is not limited to these Examples.

### [Preparation of Compounds Having Structure Represented by Formula (1)]

A compound represented by the following 4-A (hereinafter, also referred to as a “compound 4-A”) and a compound represented by the following 6-A (hereinafter, also referred to as a “compound 6-A”) were hydrolyzed and condensed at room temperature for 60 minutes. The molar ratio of the compound 4-A to the compound 6-A was 1:1. When the reaction mixture after the hydrolysis condensation was subjected to gel permeation chromatography (GPC), a novel peak which was not observed when the compound 4-A or the compound 6-A was singly placed under the above conditions and then subjected to GPC was observed. The number average molecular weight of this new peak in terms of polystyrene was calculated to be 1300. From the above results and ¹H-NMR measurement results, it was confirmed that a compound represented by the following 3-A was obtained as a product corresponding to the above novel peak. The new peak had a shoulder, and it was confirmed that the compound represented by the following 3-B was also produced, from the number average molecular weight in terms of polystyrene calculated based on the shoulder. In addition, as a result of subjecting the product to ¹³C-NMR measurement, peaks considered to be (CH₃O)₁, (CH₃O)₂, or SiCH₂ in the product were confirmed over 5 to 7 ppm, which is a region where no peaks were observed when the raw materials were subjected to the same measurements.

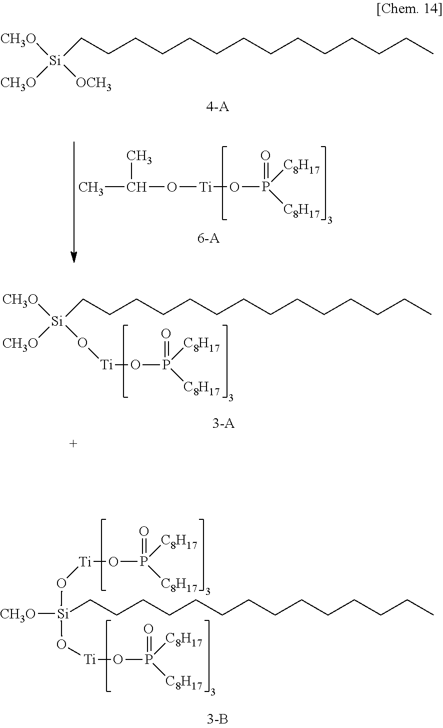

### [Preparation and Evaluation of Coated Particles]

### (Preparation of Titanium Oxide Particles)

Titanium oxide particles were recovered with reference to Example 8 of International Publication WO 2020/106860. When observed by TEM, the titanium oxide particles had a spherical shape and a particle diameter of 7 nm. In Table 1, the titanium oxide particles are denoted as “TiO₂”.

### (Preparation of Coated Particles)

The titanium oxide particles and the compound 4-A were mixed in a 20 ml vial at ratios shown in Table 1 and stirred at 110° C. for 30 minutes. Thereafter, the compound 6-A was further added to the vial and stirred at 110° C. for 20 minutes to obtain coated particles. In Comparative Example 1, gelation occurred at this stage, and the subsequent evaluation could not be performed. The reaction was carried out in PGMEA. The washing conditions of the coated particles were sorted by cases as follows.
1. N-heptane was added to the reaction system containing PGMEA to precipitate the coated particles, followed by centrifugation.
(This condition is denoted as 1 in the row of washing conditions in Table 1.)
2. The centrifuged coated particles were then collected, and dispersed in tetrahydrofuran (THF), and heptane was added to precipitate the coated particles, followed by centrifugation.
(This condition is denoted as 2 in the row of washing conditions in Table 1.)
3. Again, the centrifuged coated particles were collected and dispersed in tetrahydrofuran (THF), and heptane was added to precipitate the coated particles, followed by centrifugation.
(This condition is denoted as 3 in the row of washing conditions in Table 1.)

### (Evaluation of Coated Particles)

### Dispersibility

With regard to the coated particles filtered, washing with n-heptane as washing liquid, filtration, subsequent drying at 25° C., redispersion in PGMEA as a dispersion medium and filtration were attempted. The dispersibility of the coated particles was evaluated based on the following criteria. The results are shown in Table 1.
+(good): all of washing, drying, redispersion and filtration were possible.
− (poor): the coated particles were gelled, and at least one of washing, drying, redispersion or filtration was not possible, and subsequent measurements were not possible.

### XPS

The coated particles prepared were subjected to X-ray photoelectron spectroscopy (XPS analysis) to calculate a molar ratio between phosphorus and silicon contained in the coated particles. Based on this, the molar ratio between a portion derived from the compound 6-A and a portion derived from the compound 4-A in the coated particles was calculated. The results are shown in Table 1.

### Coating Ratio

The coated particles filtered were redispersed in PGMEA as the dispersion medium to prepare a 50 mass % dispersion. This dispersion was subjected to thermogravimetric analysis (TGA), and the ratio of the total of the portion derived from the compound 6-A and the portion derived from the compound 4-A to the solid content in the dispersion was calculated to obtain the coating ratio (mass %) of the coated particles. The results are shown in Table 1.

### Refractive Index

With regard to the coated particles, as the titanium content of the portion that coats the titanium oxide particles (that is, the sum of the portion derived from the compound 6-A and the portion derived from the compound 4-A) increases, the refractive index of the coated particles more easily improves. Since titanium is contained in the portion derived from the compound 6-A, it is reasonable to understand that the higher the amount of the portion derived from the compound 6-A, the more easily does the refractive index of the coated particles improve. Therefore, the refractive index of the coated particles was evaluated by the following criteria using the molar ratio (hereinafter, also referred to as “compound 6-A/compound 4-A”) by XPS between the compound 6-A-derived portion and the compound 4-A-derived portion. The results are shown in Table 1.
++ (very good): compound 6-A/compound 4-A was 0.5 or more.
+ (good): compound 6-A/compound 4-A was greater than 0 and less than 0.5.
− (poor): compound 6-A/compound 4-A was 0. Alternatively, the dispersibility of the coated particles was poor.

### Particle Size in Dispersion Composition

The coated particles of each of Examples 1 to 5 were dispersed in a dispersion medium such as PGMEA at a concentration of 5% by mass or less to obtain a dispersion composition, and the average diameter of the coated particles in the dispersion composition was measured by Malvern Zetasizer Nano S (Dynamic Light Scattering (DLS) apparatus). As a result, the average diameter was 20 nm or less in any of Examples 1 to 5.

TABLE 1

| Comparative | | | | | | |
|---|---|---|---|---|---|---|
| Example | | Example | | | | |
| 1 | 2 | 1 | 2 | 3 | 4 | 5 |

Preparation of coated particles

| | | | | | | | | |
|---|---|---|---|---|---|---|---|---|
| Particles | | TiO₂ | TiO₂ | TiO₂ | TiO₂ | TiO₂ | TiO₂ | TiO₂ |
| Ratio of total of | Mass % | 30 | 30 | 30 | 40 | 40 | 40 | 45 |
| compounds 6-A and | | | | | | | | |
| 4-A to particles | | | | | | | | |
| Ratio of compound | Weight | 1/0 | 0/1 | 1/2 | 1/3 | 1/1 | 1/1 | 2.5/2 |
| 6-A to compound 4-A | ratio | | | | | | | |
| | Molar | 1/0 | 0/1 | 1/6 | 1/9 | 1/3 | 1/3 | 2/5 |
| | ratio | | | | | | | |
| Washing condition | | — | 1 | 1 | 1 | 1 | 3 | 3 |

Evaluation of coated particles

| | | | | | | | | |
|---|---|---|---|---|---|---|---|---|
| Dispersibility | | − | + | + | + | + | + | + |
| Ratio of P to Si by | Molar | Measurement | 0 | 1.0 | 0.8 | 1.5 | 1.8 | 1.8 |
| XPS | ratio | impossible | | | | | | |
| Ratio of compound | Molar | Measurement | 0/1 | 1/3 | 1/4 | 1/2 | 3/5 | 3/5 |
| 6-A-derived portion | ratio | impossible | (0.00) | (0.33) | (0.25) | (0.50) | (0.60) | (0.60) |
| to compound | | | | | | | | |
| 4-A-derived | | | | | | | | |
| portion by XPS | | | | | | | | |
| Coating ratio | Mass % | Measurement | 14.5 | 14.0 | 14.5 | 14.9 | 13.7 | 13.5 |
| | | impossible | | | | | | |
| Refractive index | | − | − | + | + | ++ | ++ | ++ |

As can be seen from Table 1, it was confirmed that the particles obtained in the Examples were excellent in dispersibility and refractive index, whereas the particles obtained in the Comparative Examples were poor in dispersibility or refractive index.

1. A compound having a structure represented by the following formula (1): 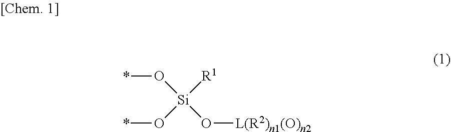
wherein R¹ represents an organic group having 1 to 30 carbon atoms;
R² represents a group represented by OR³ or a group represented by the following formula (2);
R³ represents an organic group having 1 to 30 carbon atoms;
n1 and n2 each independently represent an integer of 0 or more, provided that n1+2×n2 is a valence determined by the type of L;
L represents aluminum, gallium, yttrium, titanium, zirconium, hafnium, bismuth, tin, vanadium, or tantalum; and
* represents a bond; 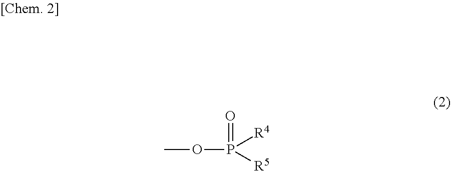
wherein R⁴ and R⁵ each represent an organic group having 1 to 30 carbon atoms which may have an oxygen atom.

2. The compound according to claim 1, wherein the compound is represented by the following formula (3): 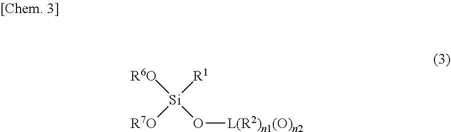
wherein R¹, R², n1, n2, and L are as defined above, and R⁶ and R⁷ each independently represent an organic group having 1 to 30 carbon atoms or a group represented by L(R²)ₙ₁(O)ₙ₂.

3. The compound according to claim 1, wherein the compound is represented by the following formula (30): 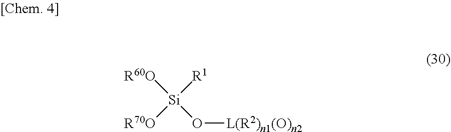
wherein R¹, R², n1, n2, and L are as defined above, and R⁶⁰ and R⁷⁰ each represent an organic group having 1 to 30 carbon atoms.

4. Particles having a structure represented by the following formula (1) on the surface: 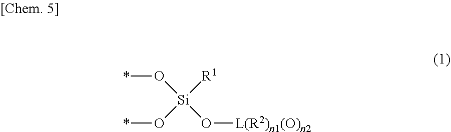
wherein R¹ represents an organic group having 1 to 30 carbon atoms;
R² represents a group represented by OR³ or a group represented by the following formula (2);
R³ represents an organic group having 1 to 30 carbon atoms;
n1 and n2 each independently represent an integer of 0 or more, provided that n1+2×n2 is a valence determined by the type of L;
L represents aluminum, gallium, yttrium, titanium, zirconium, hafnium, bismuth, tin, vanadium, or tantalum; and
* represents a bond, and 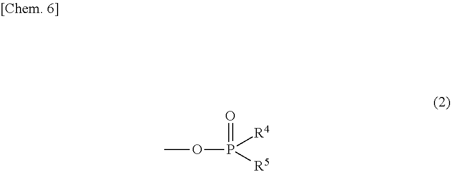
where R⁴ and R⁵ each represent an organic group having 1 to 30 carbon atoms which may have an oxygen atom.

5. A dispersion composition comprising particles according to claim 4.

6. A method of producing particles having a structure represented by the following formula (1) on the surface,
the producing method comprising:
reacting particles having a hydroxyl group on the surface with a compound represented by the following formula (30) to obtain coated particles having a structure represented by the formula (1) on the surface,
or
the producing method comprising:
firstly reacting particles having a hydroxyl group on the surface with a compound represented by the following formula (4) to obtain particles having a structure represented by the following formula (5) on the surface; and
secondly reacting particles obtained in the firstly reacting with a compound represented by the following formula (6) to obtain particles having a structure represented by the following formula (1) on the surface; 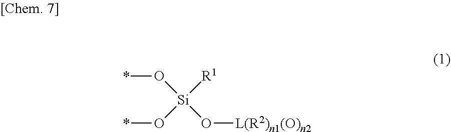
wherein R¹ represents an organic group having 1 to 30 carbon atoms;
R² represents a group represented by OR³ or a group represented by the following formula (2);
R³ represents an organic group having 1 to 30 carbon atoms;
n1 and n2 each independently represent an integer of 0 or more, provided that n1+2×n2 is a valence determined by the type of L;
L represents aluminum, gallium, yttrium, titanium, zirconium, hafnium, bismuth, tin, vanadium, or tantalum; and
* represents a bond 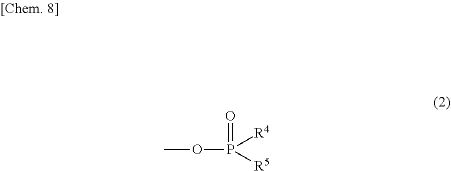
wherein R⁴ and R⁵ each represent an organic group having 1 to 30 carbon atoms which may have an oxygen atom, 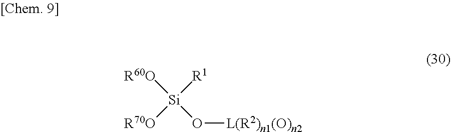
wherein R¹, R², n1, n2, and L are as defined above, and R⁶⁰ and R⁷⁰ each represent an organic group having 1 to 30 carbon atoms, 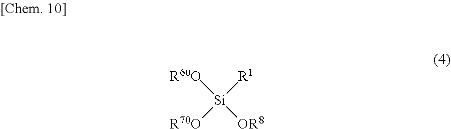
wherein R¹, R⁶⁰, and R⁷⁰ are as defined above, and R¹ represents an organic group having 1 to 30 carbon atoms, 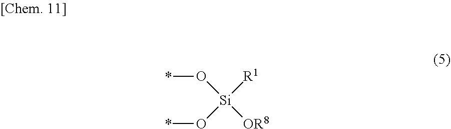
wherein R¹ and R⁸ are as defined above,
R⁹O-L(R²)ₙ₁(O)ₙ₂ (6)
wherein R², n1, n2, and L are as defined above, and R⁹ represents an organic group having 1 to 30 carbon atoms.
